(19) United States
(12) Patent Application Publication
(10) Pub. No.: US 2007/0183446 A1
(43) Pub. Date: Aug. 9, 2007

(54) Broadband and narrowband service processing apparatus in communication equipment and its implementation method

(76) Inventor: Ming Huang, Guangdong (CN)

Correspondence Address: LADAS & PARRY, 5670 WILSHIRE BOULEVARD, SUITE 2100, LOS ANGELES, CA, 90036-5679, US

(21) Appl. No.: 10/556,413

(22) PCT Filed: Mar. 1, 2004
(86) PCT No.: PCT/CN04/00157

§ 371 Date: Mar. 6, 2007

(30) Foreign Application Priority Data
May 12, 2003 (CN) 03131114.8

(51) Int. Cl. H04L 12/66; H04J 1/00

(52) U.S. Cl. 370/463; 370/484

(57) ABSTRACT

The present invention relates to a broadband and narrowband service processing apparatus in communication equipment and its implementation method. In the present invention, the LPF module, the HPF module, and the XDSL service processing module included in the broadband and narrowband service processing apparatus is disposed in one and the same line card that occupies only one slot in the communication equipment, so as to greatly increase the number of ports that can be provided by the same communication equipment at central office end and reduce the cost per subscriber access port provided by the communication equipment at central office end. In addition, when the broadband and narrowband service processing apparatus according to an embodiment of the present invention is connected with the external line of subscriber, it requires significantly fewer connecting cables and connectors than the existing broadband and narrowband service processing apparatuses, thereby further reducing the implementing cost per port provided by the communication equipment at central office end.

### FIELD OF THE INVENTION

The present invention relates to communication technology field, especially to a broadband and narrowband service processing apparatus in communication equipment and its implementation method.

### BACKGROUND OF THE INVENTION

In the communication technology field, as communication technology develops, widespread use of broadband services becomes a certainty, and the advantages of broadband transmission are known to all. Not with standing this, in consideration of the benefits of operators and people's habits, broadband services have to coexist with legacy narrowband services in the existing communication networks. Therefore, it is a new challenge to implement a method and/or an apparatus that can process both broadband and narrowband services simultaneously in a communication system.

Presently, in communication systems, broadband and narrowband services are provided simultaneously through copper twisted pairs to subscribers; the broadband service includes Asymmetric Digital Subscriber Loop (ADSL) Service and Very-high-speed Digital Subscriber Loop (VDSL) Service, etc., which are called collectively as XDSL services; and the narrowband service includes Plain Old Telephone Service (POTS) and Integrated Service Digital Network (ISDN), etc. There are several cases in which broadband and narrowband services can be processed simultaneously in a communication network: ADSL over POTS, ADSL over ISDN, VDSL over POTS, and VDSL over ISDN, etc.

The fundamental principle of the cases in which broadband and narrowband services can be processed simultaneously is shown in FIG. 1; in a copper twisted pair that is used as the external line of subscriber, broadband service signal (i.e., high frequency XDSL signal) and narrowband service signal (i.e., low frequency POTS/ISDN signal) coexist with each other.

In the equipment at central office end, there is a Low-Pass Filter (LPF) module and a High-Pass Filter (HPF) module, which filter mixed signal in the external line of subscriber to separate high-frequency signal and low-frequency signal from each other and transmit them to the respective processing modules; the LPF module and the HPF module usually comprises multiple LPFs and multiple HPFs respectively; one LPF and one HPF cooperate with each other to process one channel of the mixed signal in the external line of subscriber. The LPF separates out the narrowband service POTS/ISDN signal and sends it to the port of POTS/ISDN line card in the narrowband telephone switch at central office end for service processing; and the HPF separates out XDSL signal and sends it to the port of XDSL line card in a Digital Subscriber Line Access Multiplexer (DSLAM) (broadband equipment at central office end) for service processing. The HPF circuit is usually built in the XDSL line card, as shown in FIG. 1.

In the equipment at subscriber end, the narrowband signal separated out by the LPF module is sent to the subscriber's telephone, and the XDSL signal is sent to the Remote Terminal Unit (RTU), which has a HPF module designed to filter off low frequency POTS/ISDN signal and perform service processing on the high frequency XDSL signal.

Corresponding to each copper twisted pair connected to the equipment at subscriber end, there is one LPF and one port of service processing portion for low frequency POTS/ISDN signal as well as one HPF and one port of service processing portion for XDSL signal. As shown in FIG. 1, the DSLAM comprises multiple separate LPF modules and XDSL line cards; wherein, each LPF module corresponds to one XDSL line card, and each LPF module or XDSL line card is separately inserted into the corresponding slot in the DSLAM and thus occupies one slot. Each LPF module and its corresponding XDSL line card can be connected to multiple subscribers; for example, one LPF module and XDSL line card comprising 32 circuits can be connected to 32 equipments at subscriber end. The separate LPF modules and the XDSL line cards are connected through cable, and the LPF modules and the POTS/ISDN line cards are also connected through cable; said cable comprises multiple copper twisted pairs which, in the case of 32-channel LPF modules and XDSL line cards, are 32 copper twisted pairs.

Therefore, in the DSLAM, due to the fact that each LPF module or XDSL line card occupies one slot in the frame of the DSLAM, the maximum number of the subscriber access ports can be provided by the DSLAM in the communication system is reduced significantly, i.e., the capacity of the DSLAM in the system is reduced. In addition, in the DSLAM, it is required for each LPF module and the XDSL line card to be connected through a cable, causing a large amount of cables and connectors to be used, and increasing the complexity in implementing DSLAM and the cost of the same; even if each LPF module and the XDSL line card are connected through the wiring on a PCB (Printed Circuit Board), the implementing cost will also be increased due to the use of a large amount of connectors, and at the same time, the complexity in wiring on the PCB will be increased greatly.

### SUMMARY OF THE INVENTION

In view of above problems in the prior art, it is an object of the present invention to provide a broadband and narrowband service processing apparatus in communication equipment and its implementation method, so as to reduce the cost for the implementing the broadband and narrowband service processing apparatus and reduce the complexity in the same significantly.

The object of the present invention is achieved with the following solution:

said broadband and narrowband service processing apparatus in communication equipment, comprising:

LPF module, HPF module, broadband service line card, and narrowband service line card; said LPF and HPF modules being built in the broadband service line card, the HPF module being connected with a broadband service signal processing module in the broadband service line card, and the LPF module being connected with the narrowband service line card.

Each of said broadband service line cards occupies one slot in the communication equipment.

Said broadband service line card has a broadband service signal processing module disposed therein, which is designed to process broadband service signal in the communication system;

said narrowband service card has a narrowband service signal processing module disposed therein, which is designed to process narrowband service signal in the communication system;

said LPF module and HPF module are designed to separate broadband service signal and narrowband service signal mixed in the respective transmission line; wherein, said LPF module is designed to filter off broadband service signal in the transmission line and output narrowband service signal; said HPF module is designed to filter off narrowband service signal in the transmission line and output broadband service signal.

Said communication equipment is a DSLAM (Digital Subscriber Line Access Multiplexer);

said broadband service card is a XDSL line card;

said broadband service signal processing module is a XDSL service processing module in the XDSL line card;

said narrowband service card is a POTS/ISDN line card;

said narrowband service signal processing module is a POTS/ISDN service processing module in the POTS/ISDN line card.

Said HPF module is connected with the broadband service signal processing module through the wiring on a PCB (Printed Circuit Board); said LPF module is connected with the POTS/ISDN line card through the external cable and connector.

Said POTS/ISDN line card can be located in a slot of said DSLAM or in the narrowband telephone switch equipment external to the DSLAM equipment.

The number of LPFs in said LPF module is equal to that of HPFs in said HPF module, and one LPF cooperates with one HPF to process one channel of the mixed signal comprising the broadband service signal and the narrowband service signal.

Said method of implementing broadband and narrowband service processing apparatus in communication equipment, comprising:

determining LPF (Low-Pass Filter) module, HPF (High-Pass Filter) module, narrowband service signal processing module, and broadband service signal processing module included in the broadband and narrowband service processing apparatus;

disposing the LPF module, the HPF module, and the broadband service signal processing module on one and the same line card in said communication equipment;

connecting the LPF module with the narrowband service signal processing module; connecting the HPF module with the broadband service signal processing module.

Said broadband service includes: ADSL (Asymmetric Digital Subscriber Loop) service, VDSL (Very-high-speed Digital Subscriber Loop) service, ADSL+ service, ADSL2 service, and ADSL2+ service;

said narrowband service includes: POTS service and ISDN service.

It can be seen from above technical solution provided by the present invention that, since the present invention employs a structure that integrates LPF module and HPF module with XDSL line card, the broadband and narrowband service processing apparatus in the communication system only occupies one slot in the communication equipment such that in the case that the DSLAM occupies the same volume (space), the number of the ports could be provided is increased greatly, the space occupation for installation of the communication equipment being reduced efficiently; at the same time, the cost per subscriber access port provided by the DSLAM is reduced. In addition, with the present invention, the connecting cables and connectors between the LPF and the XDSL line card corresponding to each channel of the mixed signal in the existing communication equipment can be omitted, further reducing the implementing cost per port provided by the communication equipment at central office end.

### BRIEF DESCRIPTION OF THE DRAWINGS

FIG. 1 is a structural representation of a broadband and narrowband service processing apparatus in the prior art;

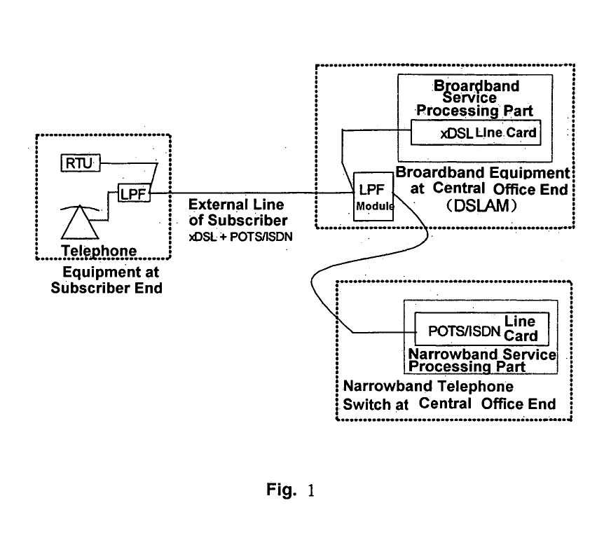

FIG. 2 is a network topology diagram of a broadband and narrowband service processing apparatus according to an embodiment of the present invention;

FIG. 3 is a structural representation of the XDSL line card shown in FIG. 2.

### DETAILED DESCRIPTION OF THE EMBODIMENTS

In a communication system, the broadband and narrowband service processing apparatus for processing broadband and narrowband service signal transmitted in the external line of subscriber usually comprises LPF (Low-Pass Filter) module and HPF (High-Pass Filter) module, and broadband service signal processing module and narrowband service signal processing module, respectively, in the broadband service processing part and the narrowband service processing part. The method of implementing the broadband and narrowband service processing apparatus in the communication system according to an embodiment of the present invention comprises: disposing the LPF module and the HPF module of the broadband and narrowband service processing apparatus on one and the same line card that only occupies one slot in the communication equipment, so as to ensure that only one slot in the communication equipment is needed to be occupied in the case that the narrowband service processing module is disposed externally to the communication equipment; the LPF module and the HPF module are designed to separate out broadband service signal and narrowband service signal in one and the same transmission line; wherein: the LPF module is designed to filter off broadband service signal in the transmission line and output narrowband service signal to the narrowband service signal processing module in the narrowband service processing part; the narrowband service signal processing module may be built in the communication equipment or external to the communication equipment; the HPF module is designed to filter off narrowband service signal in the transmission line and output broadband service signal to the broadband service signal processing module in the broadband service processing part. The present invention significantly increases the number of broadband and narrowband service processing apparatuses that can be inserted in the communication equipment, i.e., the number of the equipments at subscriber end that could be supported by single communication equipment at central office end, DSLAM.

The line card is a broadband service line card that contains a broadband service signal processing module in the communication equipment, the broadband service line card is designed to process broadband service signal transmitted in the external line of subscriber; the broadband service line card can be a XDSL (X Digital Subscriber Loop) line card in the current broadband equipment at central office end.

The broadband service according to the embodiment of the present invention includes: ADSL (Asymmetric Digital Subscriber Loop) service, VDSL (Very-high-speed Digital Subscriber Loop) service, ADSL+ service, ADSL2/ADSL2+ service, etc.;

the narrowband service according to the embodiment of the present invention includes: POTS service and ISDN service, etc.

Therefore, the method according to the embodiment of the present invention can be applied to the communication equipment that provides ADSL over POTS service, and/or ADSL over ISDN service, and/or VDSL over POTS service, and/or VDSL over ISDN service, etc.

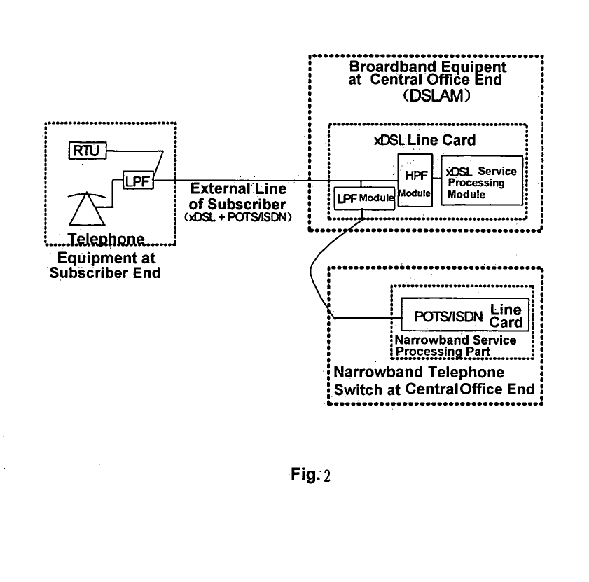

On the basis of the above method, the present invention also provides a broadband and narrowband service processing apparatus in communication equipment, the structure of which is shown in FIG. 2, comprising: LPF module, HPF module, broadband service line card, and narrowband service line card; the LPF module and the HPF module being built in the broadband service line card, and the LPF module being connected with the narrow band service line card containing a narrowband service signal processing module, through the external cable and the connector; the broadband service line card being in the broadband equipment at central office end, DSLAM, and occupying one slot in the broadband equipment at central office end, for processing broadband service signal in the communication system; the LPF module and the HPF module, respectively, processing the mixed signal in the external line of subscriber directly; the LPF and the HPF are connected with the external line of subscriber at a combined connecting point; the other end of the external line of subscriber is connected the equipment at subscriber end.

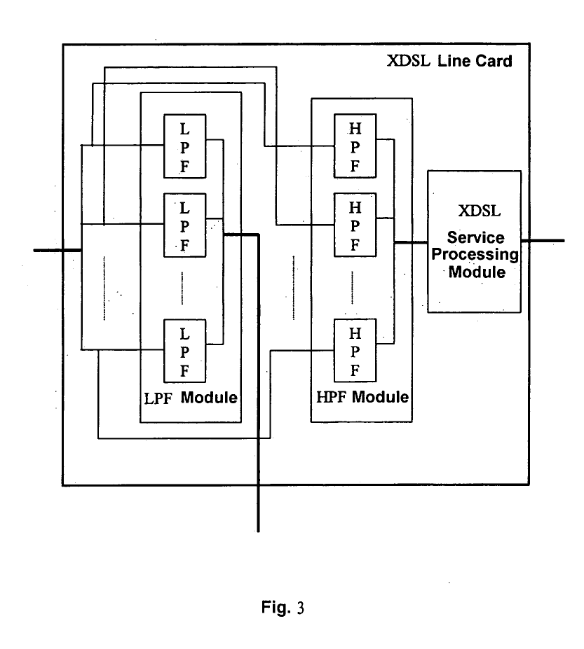

In above apparatus, if the broadband service line card is a XDSL line card and the narrowband service line card is a POTS/ISDN line card, the HPF module is connected with the XDSL service processing module in the XDSL line card, as shown in FIG. 3; the LPF module and the HPF module in the apparatus process the mixed signal comprising broadband service signal and narrowband service signal i.e., XDSL signal and POTS/ISDN signal, respectively, in the external line of subscriber; wherein: the LPF module processes the mixed signal through low-pass filtering to obtain low frequency POTS/ISDN signal (i.e., narrowband service signal) and transmits the signal obtained through the cable to the POTS/ISDN line card for processing; the HPF module processes the mixed signal through high-pass filtering to obtain the high frequency XDSL signal (i.e., broadband service signal) and transmits the signal obtained within the XDSL line card to the XDSL service processing module for processing; each LPF and HPF being connected in FIG. 3 cooperates with each other to process each channel of the mixed signal, each channel of the signal corresponding to a subscriber terminal.

In the present invention, it is unnecessary to modify the design of the existing LPF module and the modules in the XDSL line card due to the fact that the XDSL line card in the existing communication equipment has enough slots to accommodate additional LPF modules; therefore, through simply disposing the LPF module in the XDSL line card and carrying out the respective connection for the LPF module and the HPF module on a PCB in a manner as shown in FIG. 3, the LPF module can be built in the XDSL line card, so as to save the slots in the communication equipment occupied originally by the LPF module, and thereby enable the communication equipment to accommodate more XDSL line cards and provide more subscriber access ports.

1. A broadband and narrowband service processing apparatus in communication equipment, comprising:
LPF module, HPF module, broadband service line card, and narrowband service line card; said LPF module and HPF module being built in the broadband service line card; said HPF module being connected with a broadband service signal processing module in said broadband service line card; said LPF module being connected with the narrowband service line card.

2. The broadband and narrowband service processing apparatus in communication equipment as in claim 1, characterized in that each of said broadband service line cards occupies one slot in the communication equipment.

3. The broadband and narrowband service processing apparatus in communication equipment as in claim 1, characterized in that
said broadband service line card has a broadband service signal processing module disposed therein, which is designed to process broadband service signal in the communication system;
said narrowband service line card has a narrowband service signal processing module disposed therein, which is designed to process narrowband service signal in the communication system;
said LPF module and HPF module are designed to separate broadband service signal and narrowband service signal mixed in the respective transmission line; wherein, said LPF module is designed to filter off broadband service signal in the transmission line and output narrowband service signal; said HPF module is designed to filter off narrowband service signal in the transmission line and output broadband service signal.

4. The broadband and narrowband service processing apparatus in communication equipment as in claim 1, characterized in that
said communication equipment is a DSLAM (Digital Subscriber Line Access Multiplexer);
said broadband service line card is a XDSL line card;
said broadband service signal processing module is a XDSL service processing module in the XDSL line card;
said narrowband service line card is a POTS/ISDN line card;
said narrowband service signal processing module is a POTS/ISDN service processing module in the POTS/ISDN line card.

5. The broadband and narrowband service processing apparatus in communication equipment as in claim 4, characterized in that said HPF module is connected with the broadband service signal processing module through the wiring on a PCB (Printed Circuit Board); said LPF module is connected with the POTS/ISDN line card through the external cable and connector.

6. The broadband and narrowband service processing apparatus in communication equipment as in claim 4, characterized in that said POTS/ISDN line card can be located in a slot of said DSLAM or in the narrowband telephone switch equipment external to the DSLAM equipment.

7. The broadband and narrowband service processing apparatus in communication equipment as in claim 1, characterized in that the number of the LPFs in said LPF module is equal to that of the HPFs in said HPF module, and one LPF cooperates with one HPF to process one channel of the mixed signal comprising broadband service signal and narrowband service signal.

8. A method of implementing broadband and narrowband service processing apparatus in communication equipment, comprising:
determining LPF(Low-Pass Filter) module, HPF (High-Pass Filter) module, narrowband service signal processing module, and broadband service signal processing module included in the broadband and narrowband service processing apparatus;
disposing the LPF module, the HPF module, and the broadband service signal processing module on one and the same line card in said communication equipment;
connecting the LPF module with the narrowband service signal processing module; connecting the HPF module with the broadband service signal processing module.

9. The method of implementing broadband and narrowband service processing apparatus in communication equipment as in claim 8, wherein:
said broadband service includes: ADSL (Asymmetric Digital Subscriber Loop) service, VDSL (Very-high-speed Digital Subscriber Loop) service, ADSL+ service, ADSL2 service, and ADSL2+ service;
said narrowband service includes: POTS service and ISDN service.
